(19) United States
(12) Patent Application Publication
(10) Pub. No.: US 2009/0122161 A1
(43) Pub. Date: May 14, 2009

(54) IMAGE TO SOUND CONVERSION DEVICE

(75) Inventor: Igor Bolkhovitinov, St. Petersburg (RU)

Correspondence Address: DOVAS LAW P.C., 307 BAINBRIDGE STREET, PHILADELPHIA, PA, 19147, US

(73) Assignee: TECHNICAL VISION INC., Southampton, PA (US)

(21) Appl. No.: 11/936,797

(22) Filed: Nov. 8, 2007

(51) Int. Cl. H04N 9/68; H04N 5/228; H04R 5/00

(52) U.S. Cl. 348/234; 348/222.1; 381/1; 348/E05.031; 348/E09.053

(57) ABSTRACT

A device for creating a sound map of a three dimensional view area is provided. The device comprises a first camera configured to capture and transmit a first image and a second camera positioned a predetermined distance from the first camera configured to capture and transmit a second image. An image processing system is connected to the first camera and the second camera and is configured to create a three dimensional topographic plan of the three dimensional view area based on a comparison of the first image with the second image and the predetermined distance between the first camera and the second camera. The image processing system is further configured to transform the three dimensional topographic plan into a sound map comprising volume gradients and tone gradients. The present invention further provides methods of creating a sound map of a three dimensional view area.

### BACKGROUND

Countless people who are blind or have reduced vision capacity often struggle to perform tasks that those with reliable sight can perform with minimal effort. While strides have been made to accommodate the blind and vision impaired in modern society, there are still great difficulties which still need to be overcome to allow those whose sight is handicapped to live a more independent and productive life. Some known devices exist which utilize emitted sounds to provide a blind or vision impaired user with information about his or her physical environment, such information collected by a suitable sensing instrument. However, such known devices are limited in their ability to collect and process information regarding a user's surroundings, and therefore limited with respect to the quality and usability of the information delivered to a user.

In view of the above, it would be desirable to provide a device which is capable of capturing and processing information regarding a blind or visually impaired person's surroundings and capable of delivering that information in audio form to permit such person to have a greater understanding of his or her physical environment.

### SUMMARY

The present invention provides a system that converts a visual space into sounds of varying tones and volumes allowing a blind or visually impaired person to have a dynamic understanding of the visual space including the objects around him or her. Stereoscopic information is dynamically transformed into stereophonic information for helping to spatially orient a user of the system. Height coordinates are preferably modeled by sound tones through a range of one or more octaves. Color gamma is preferably also modeled by sound tones, with different sound frequency ranges associated with each of three colors, red, green and blue. Brightness is preferably modeled by volume. The directional positioning of features of the visual space is preferably defined stereophonically.

The invention preferably provides for two or more sensory zones. Information in a near zone is identified by triangulation using two substantially simultaneously captured images which are updated at a predetermined interval as the user moves, changing a frame of reference of captured images, the information being represented by varying sound frequency. In a far zone, distance is preferably represented by a discreet sound frequency, wherein a lower tone is associated with surfaces which are farther away, and a higher tone is associated with surfaces which are closer.

The range and scale of the sensory zones are preferably user adjustable or automatically adjustable. Surface height or unevenness in at least one zone is preferably defined by sound tone varying through a range of one or more octaves based on a predetermined sound frequency scale suitable for a particular environment. For example, road irregularities encountered by a walking user may be differentiated by implementing a sound frequency scale in which one sound octave is equal to about 70 centimeters, whereby 10 centimeters is equal to one note of a standard seven note octave. If a very high object, for example a building, requires visualization by a user, then a sound frequency scale in which one sound octave is equal to tens of meters, for example 30 meters, is preferably implemented. To help a user differentiate natural sounds from modeled sounds, the system preferably relays modeled sounds discreetly.

The present invention further provides a method to differentiate the surface textures of objects by three dimensional characteristics including color, reflection factor, and level of polarization to allow a user to differentiate for example dry or wet asphalt, snow, grass, and other surfaces.

The present invention further provides a device for creating a sound map of a three dimensional view area. The device comprises a first camera configured to capture and transmit a first image and a second camera positioned a predetermined distance from the first camera configured to capture and transmit a second image. An image processing system is connected to the first camera and the second camera and is configured to create a three dimensional topographic plan of the three dimensional view area based on a comparison of the first image with the second image and based on the predetermined distance between the first camera and the second camera. The image processing system is further configured to transform the three dimensional topographic plan into a sound map comprising volume gradients and tone gradients.

The present invention further provides a method of creating a sound map of a three dimensional view area. The method comprises providing a first camera directed toward the three dimensional view area, providing a second camera directed toward the three dimensional view area and positioned a predetermined distance from the first camera, and providing a processing system connected to the first camera and the second camera. A first image is transmitted of the three dimensional view area from the first camera to the processing system, and a second image is transmitted of the three dimensional view area from the second camera to the processing system. The first image is compared with the second image and a three dimensional topographic plan is created with the processing system based on the comparison of the first image and the second image and the predetermined distance between the first camera and the second camera. Using the processing system the three dimensional topographic plan is transformed into a sound map comprising volume gradients and tone gradients.

The present invention further provides another method for creating a sound map of a three dimensional view area. The method comprises capturing a first image of the three dimensional view area from a first vantage point, whereby the first image comprises a first plurality of line brightness functions. A second image of the three dimensional view area is captured from a second vantage point a predetermined distance from the first vantage point, whereby the second image comprises a second plurality of line brightness functions. The first plurality of line brightness functions is compared with the second plurality of line brightness functions and a three dimensional topographic plan is created based at least on the comparison of the first and second plurality of line brightness functions and based on the predetermined distance between the first vantage point and the second vantage point. A sound map is created based on the three dimensional topographic plan, wherein the sound map comprises volume gradients and tone gradients.

### BRIEF DESCRIPTION OF THE DRAWING(S)

The foregoing Summary as well as the following detailed description will be readily understood in conjunction with the appended drawings which illustrate preferred embodiments of the invention. In the drawings:

FIG. 1 is a perspective view of a sound mapping device in the form of a pair of glasses according to a preferred embodiment of the present invention.

FIG. 2 is a front elevation view of the sound mapping device of FIG. 1.

FIG. 3 is side elevation view of the sound mapping device of FIG. 1 taken along line 3-3 of FIG. 2.

FIG. 4 is an elevation view of a three dimensional view area showing an example implementation of the sound mapping device of FIG. 1 with some components of the sound mapping device hidden for clarity.

FIG. 5 is an example line brightness function of the three dimensional view area of FIG. 4 created by the sound mapping device of FIG. 1.

FIG. 6 is a plan view of the three dimensional view area of FIG. 4 taken along line 6-6 of FIG. 4.

FIG. 7 is a schematic diagram showing functional components of the sound mapping device of FIG. 1 including a first preferred image processing system.

FIG. 8 is a schematic diagram showing functional components of the sound mapping device of FIG. 1 including a second preferred image processing system replacing the first preferred image processing system in the sound mapping device of FIG. 1.

FIG. 9 is a schematic diagram showing functional components of the sound mapping device of FIG. 1 including a third preferred image processing system replacing the first preferred image processing system in the sound mapping device of FIG. 1.

FIG. 10 is a perspective view of a sound mapping device in the form of a pair of glasses according to another preferred embodiment of the present invention.

FIG. 11 is a front elevation view of the sound mapping device of FIG. 10.

FIG. 12 is top plan view of the sound mapping device of FIG. 10.

FIG. 13 is a method of creating a sound map of a three dimensional view area according to a preferred embodiment of the present invention.

### DETAILED DESCRIPTION OF THE PREFERRED EMBODIMENT(S)

Certain terminology is used in the following description for convenience only and is not limiting. The words “right,” “left,” “top,” and “bottom” designate directions in the drawings to which reference is made. The words “a” and “one” are defined as including one or more of the referenced item unless specifically stated otherwise. This terminology includes the words above specifically mentioned, derivatives thereof, and words of similar import. The phrase “at least one” followed by a list of two or more items, such as A, B, or C, means any individual one of A, B or C as well as any combination thereof.

The preferred embodiments of the present invention are described below with reference to the drawing figures where like numerals represent like elements throughout.

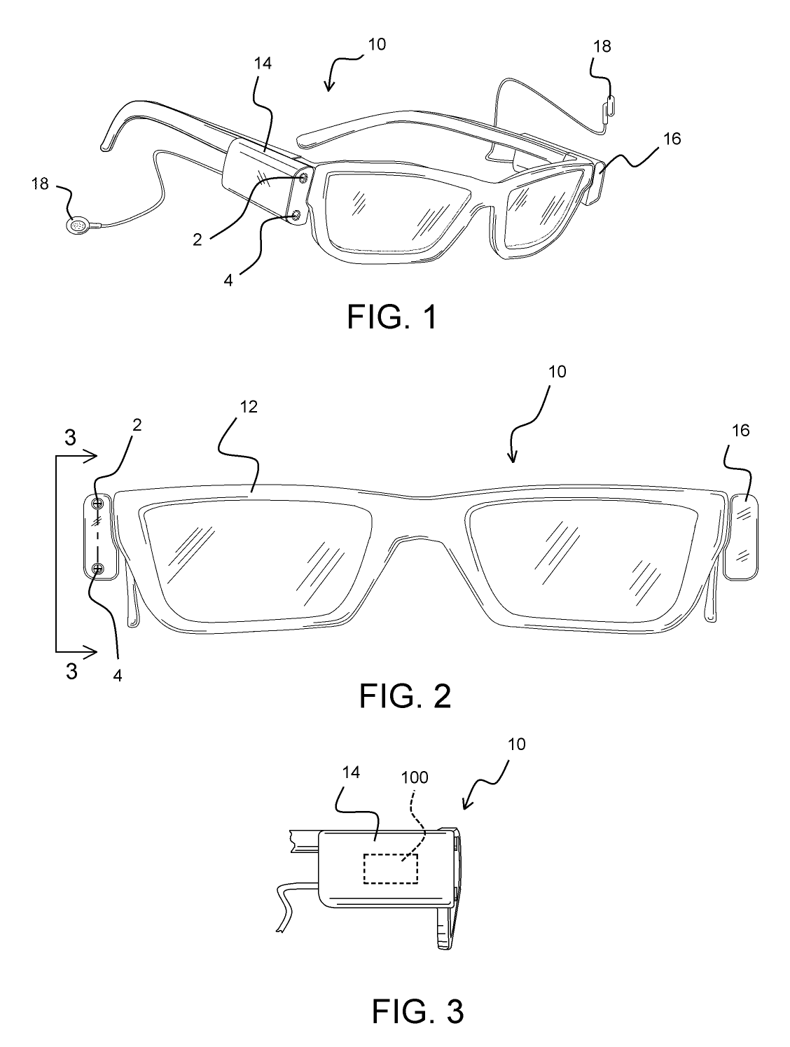

Referring to FIGS. 1-3, a device 10 according to a preferred embodiment of the present invention in the form of a pair of glasses having spectacle frames 12 for creating a sound map of a three dimensional view area, or in other terms the visual space, is shown. The sound mapping device 10 includes a body 14 holding a first camera 2 configured to capture and transmit an image, and a second camera 4 positioned a predetermined distance from the first camera 2 configured to capture and transmit an image. A first preferred image processing system 100 housed in the body 14 is connected to the first camera 2 and the second camera 4. The image processing system 100 is configured to create a three dimensional topographic plan of a three dimensional view area based at least on a comparison of a first image taken by the first camera 2 with a second image taken substantially simultaneously by the second camera 4 and the predetermined distance between the first camera 2 and the second camera 4. The image processing system 100 is further configured to transform the three dimensional topographic plan into a sound map comprising volume gradients and tone gradients to convert stereoscopic information to stereophonic information for helping to spatially orient a user of the device 10. A body 16 includes a battery for providing power to the first and second cameras 2, 4 and the image processing system 100.

The spectacle frames 12 are configured to be worn on the head of a user in a typical manner. While corrective lenses may be included with the spectacle frames 12 to assist users with at least partial vision, alternatively, non-corrective lenses or shaded lenses may be provided, or the spectacle frames may be provided without lenses.

The sound mapping device 10 is provided with audio outputs 18 in the form of speakers connected to the image processing system 100. The audio outputs 18 are preferably configured for placement attached to or in close proximity to a user's ears to permit a user to stereophonically hear a sound map emitted in amplified form by the image processing system 100. Alternatively, any suitable audio output can be used to permit a user to hear a sound map emitted from the mage processing system 100.

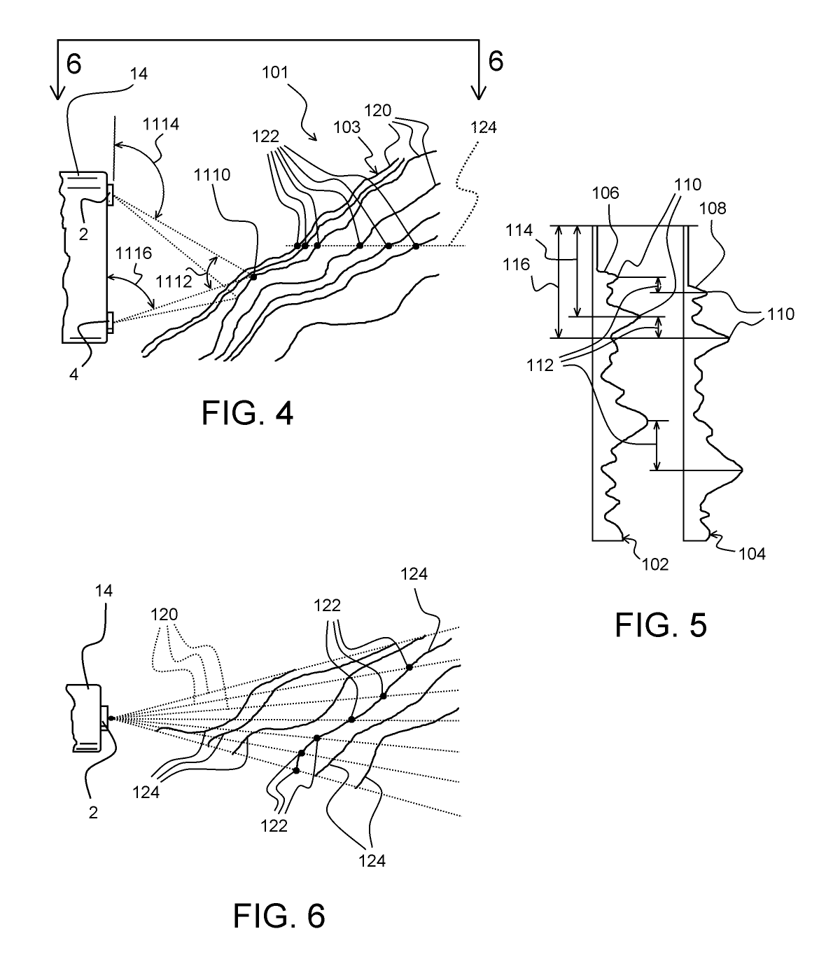

FIGS. 4-6 show an example of an implementation of the sound mapping device 10 to map a three dimensional view area 101 including a surface 103. The functionality of the sound mapping device 10 is described below with respect the three dimensional view area 101. One skilled in the art will recognize that the sound mapping device 10 could be implemented in the sound mapping of any suitable three dimensional areas.

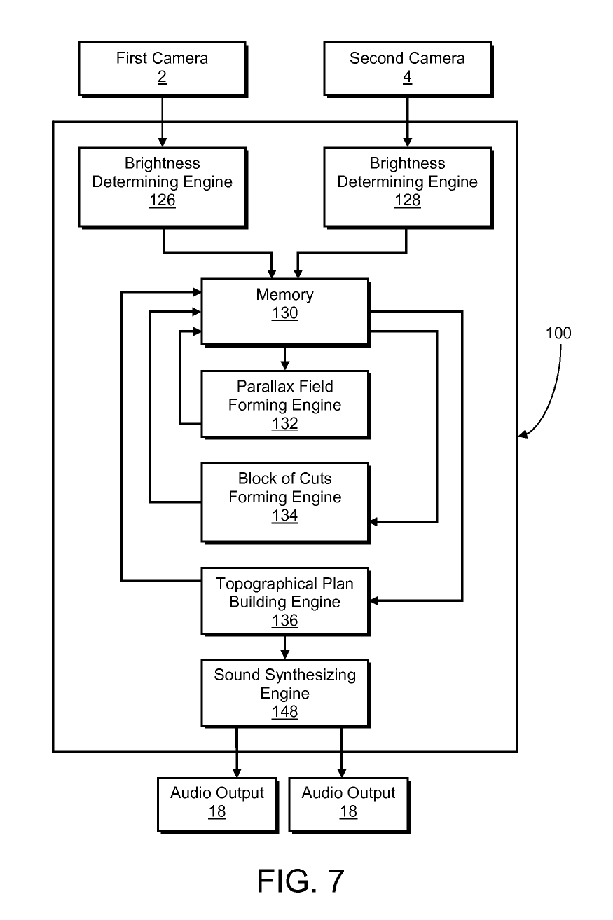

FIG. 7 shows diagrammatically functional components of the sound mapping device 10 including its image processing system 100. The image processing system 100 preferably includes brightness determining engines 126, 128 respectively connected to the first camera 2 and the second camera 4. The first and second cameras 2, 4 are preferably configured to capture images of limited size within a limited field of view to avoid burdening the processing system 100.

The brightness determining engines 126, 128 are configured to respectively identify and quantify localized extreme points of a first image captured by the first camera 2 and a second image captured by the second camera 4. To identify and quantify the localized extreme points, the brightness determining engines 126, 128 are preferably configured either to create a plurality of coplanar pairs of line brightness functions from the first and second images, or to receive the first and second images as a plurality of coplanar pairs of line brightness functions from the first and second cameras 2, 4 respectively.

Each of a first plurality of line brightness functions, for example a line brightness function 102, represents a cut 120 of the three dimensional view area 101 which is substantially coplanar with a cut 120 of the three dimensional view area 101 represented by one of the second plurality of line brightness functions, for example a line brightness function 104. The cameras 2, 4 are preferably aligned in a vertical basis image plane along a vertical line, as shown, such that the images and the corresponding line brightness functions which are produced are offset vertically but not horizontally, and the cuts 120 are representative of the line brightness functions 102, 104, which are coplanar within the vertical basis image plane. Alternatively, the cameras 2, 4 can be positioned distanced from each other in any suitable manner and the processing system 100 can configure the resulting data as required to permit a comparison of localized extreme points.

The brightness determining engines 126 are configured to identify localized extreme points of the line brightness functions 102, 104, for example the localized extreme points 110, using predetermined criteria. Preferably, the localized extreme points 110 are identified as points of slope sign change along the line brightness functions 102, 104. Alternatively, other suitable criteria may be used to define the localized extreme points 110.

The image processing system 100 preferably includes a parallax field forming engine 132 connected to the line brightness determining engines 126, 128 through a memory 130. The parallax field forming engine 132 is preferably configured to determine parallaxes 112 between corresponding ones of the localized extreme points 110 of the coplanar pairs of the line brightness functions 102, 104. The parallax field forming engine 132 compares the first line brightness function 102 with the second line brightness function 104 to match the localized extreme points 110 of the first brightness function 102 with localized extreme points of the second line brightness function 104 representing a same imaged portion of the corresponding cut 120 of the surface 103. The parallax field forming engine 132 preferably uses pattern matching algorithms in performing the comparison of the line brightness functions 102, 104 to match the corresponding localized extreme points 110.

A block of cuts forming engine 134 is connected to the parallax field forming engine 132 through a memory 130 and is configured to determine physical positions of the portions of the three dimensional view area 101 represented by the localized extreme points 110 relative to the first camera 2 and the second camera 4 based on the determination of the parallaxes 112 and the distance between the first camera 2 and the second camera 4. Preferably, triangulation is used in determining physical positions of the portions of the three dimensional view area 101 represented by the localized extreme points 110.

Referring to FIGS. 4 and 5, triangulation is performed for a given corresponding pair of localized extreme points 110, wherein a first baseline distance 114 to an extreme point 110 of the first line brightness function 102 is representative a first view angle 1114 from the first camera 2 to a determined physical position 1110, wherein a second baseline distance 116 to a corresponding matched extreme point 110 of the second line brightness function 104 is representative of a second view angle 1116 from the second camera 4 to the physical position 1110, and wherein a parallax 112, equaling a difference of the first baseline distance 114 and the second baseline distance 116, is representative of an angular difference 1112 of the first view angle 1114 and the second view angle 1116. As such, physical positions 1110 corresponding to corresponding pairs of the localized extreme points 110 can be determined geometrically along the cuts 120.

In determining how to match the extreme points 110 for determining the physical positions 1110, the aforementioned pattern matching is preferably implemented. In addition to pattern matching, the block of cuts forming engine 134 preferably uses the fact that the first view angle 1114 is always greater than the second view angle 1116, such that the first baseline distance 114 is always known to be less than the second baseline distance 116 of matched extreme points 110. Accordingly, only extreme points 110 of the first line brightness function 102 having lesser baseline distances are compared with corresponding extreme points 110 of the second line brightness function 104 for determining the matched extreme points 110. In other terms, since the second camera 4 is offset below the first camera 2, the second line brightness function 104 will be offset below the first line brightness function 102.

Preferably, the block of cuts forming engine 134 determines physical positions of portions of the three dimensional view area 101 represented by points between the localized extreme points in each of the plurality of coplanar pairs by interpolating vertically between the determined physical positions 1110 of portions of the three dimensional view area 101 at a predetermined resolution to create an interpolation of the cuts 120. Any suitable form of interpolation may be implemented including straight line or smoothed line interpolation. The block of cuts forming engine 134 further determines physical positions of portions of the three dimensional view area 101 between the cuts 120 preferably by interpolating horizontally along cuts 124 between the determined interpolation of the cuts 120 at the predetermined resolution. In such a manner, a matrix of interpolated vertical cuts 120 and interpolated horizontal cuts 124 is formed.

The interpolation of the cuts 120 is created in polar coordinates owing to the polar distribution of the cuts 120 which originate from the cameras 2, 4, as shown clearly in FIG. 6. Preferably, the positioning of the cuts 120 is converted to a Cartesian reference system by the block of cuts forming engine 134 either before or after interpolating horizontally along the cuts 124 and creating the matrix of interpolated vertical cuts 120 and interpolated horizontal cuts 124. Preferably, the block of cuts forming engine 134 also normalizes data such that the physical positions 1110 are calculated with respect to a ground plane, for example a ground plane aligned with a surface on which a user stands. For memory optimization purposes, matrix data transmitted to the memory 130 preferably overwrites or overlaps earlier data used by the processing system 100.

A topographical plan building engine 136 is connected to the block of cuts forming engine 134 through the memory 130 and is configured to create the three dimensional topographic plan based at least on the physical positions of the portions of the three dimensional view area represented by the localized extreme points determined by the block of cuts forming engine 134. Preferably, the topographical plan building engine 136 utilizes the matrix of interpolated vertical cuts 120 and interpolated horizontal cuts 124 to form the three dimensional topographic plan. Preferably, the topographic plan building engine 136 is further connected, as shown, to the brightness determining engines 126, 128 through the memory 130, and the three dimensional topographic plan is created with matrix components of both surface brightness and surface height. In this manner, information regarding shapes and forms calculated by the block of cuts forming engine 134 is combined with information regarding light reflected from the shapes and forms representing image brightness levels within the three dimensional area 101 from the brightness determining engines 126, 128, such that the three dimensional topographic plan provides a realistic picture of the three dimensional view area.

The topographic plan building engine 136 is preferably configured to create the three dimensional topographic plan defining one or more sensory zones. A near zone is defined within a predetermined distance from the device 10 including data produced by the triangulation method described above, and a far zone is provided outside of the predetermined distance from the device 10 and is defined by image brightness levels. The predetermined distance defining the range of the near zone may be any suitable distance and is preferably automatically or user adjustable. Alternatively, sensory zones in addition to the near zone and the far zone may be provided.

In certain instances it may be desirable for the topographical plan building engine 136 to build the topographic plan based on a particular reference. For example, if the cameras 2, 4 image a plurality of features on a sharp and constant slope, it may be desirable to normalize the topographic plan to remove the constant slope from the plan to increase the understandability of the topographic plan.

The topographic plan building engine 136 may additionally generate maneuverability data based on predetermined criteria selectable by a user through programming features of the processing system 100. For example, if a user desires to traverse a path free from obstructions, the user may so indicate to the processing system 100 through a suitable input method. The topographic plan building engine 136 would then preferably use the topographic plan to construct a maneuverability plan for indicating to the user a suitable path around obstructions in the environment in a scale suitable for a walking person. Also, it is preferred that the topographic building plan optimize processing capacity by eliminating data which is deemed not useful or of limited usefulness based on the predetermined criteria.

The topographic plan building engine 136 preferably additionally or alternatively generates a texture matrix, through implementation of a texture information processing engine, based on the image brightness levels to quantify surface texture and associate that surface texture with predetermined surfaces, for example dry or wet sand, leaves, dirt, liquid pools, asphalt, snow, and grass. A quality of the surface may also be associated with the surface texture through implementation of a texture information processing engine, for example sponginess or mineral content.

Preferably, the topographic plan building engine 136 is provided with filters, preferably color and polarization filters configured for analyzing the image brightness levels for producing data useful for generating the texture matrix. Preferably, such filters include a calorimeter, including for example a diaphragm, a modulator, a color separating prism, two pairs of interchangeable light filters including two color filters and two polarization filters angled at 90 degrees, and including the texture information processing engine including a pair of photo electronic photomultipliers, a pair of buffer cascades, a pair of line amplifiers, a pair of synchronized detectors connected sequentially into two parallel analog or digital voltage dividers. Images from the cameras 2, 4, which may be transmitted as image brightness levels, may pass through the diaphragm to the color separation prism, to be divided into two image data streams of equal intensity and subsequently fed into the texture information processing engine.

The topographic plan is preferably updated by the topographic plan building engine as the cameras 2, 4 transmit images to the processing system 100 at a predetermined interval. Preferably, a user can control the frequency with which images are transmitted by the cameras 2, 4, or alternatively, the frequency with which transmitted images are processed by the processing system 100.

A sound synthesizing engine 148 is connected to the topographical plan building engine 136 for transforming the three dimensional topographic plan and or any maneuverability plan into a sound map comprising volume gradients and tone gradients. Preferably, surface brightness is modeled as sound volume level and surface height or unevenness is modeled as sound tone. Alternatively, surface brightness may be modeled as sound tone and surface height or unevenness may be modeled as sound volume, or alternatively, the sound synthesizing engine can use other suitable algorithms for converting the three dimensional topographic plan into a sound map to be heard by a user. The sound synthesizing engine 148 delivers the sound map to the user in the form of amplified sound signals transmitted to the audio outputs 18.

The sound synthesizing engine 148 preferably models surface height or unevenness by sound tone varying through a range of one or more octaves based on a predetermined sound frequency scale suitable for a particular environment. For example, road irregularities encountered by a walking user may be differentiated by preferably implementing a sound frequency scale in which one sound octave is equal to about 70 centimeters, whereby 10 centimeters is equal to one note of a standard seven note octave. If a very high object, for example a building, requires visualization by a user, then a sound frequency scale in which one sound octave is equal to tens of meters, for example 30 meters, is preferably implemented. Preferably, the sound synthesizing engine 148 automatically adjusts the sound frequency scale depending on the environment. Alternatively, the scale may be adjusted based on user inputs or, if suitable, fixed without adjustability. Preferably, the implemented sound frequency scale is non-linear, and more preferably logarithmic, such that as objects become larger, a change in sound tone frequency corresponding to a given change in height becomes smaller.

The sound map is preferably generated stereophonically by the sound synthesizing engine 148. A phase shift of the sound delivered to a user is preferably determined using the following Equation 1, wherein τ is the phase shift; λ is a distance between a user's ears; vₛ is the speed of sound; xᵢ and yᵢ are coordinates of an i^{th} point in an X-Y Cartesian system of coordinates of the topographic plan having an origin at a user's position, wherein the distance to the i^{th} point from the origin is \sqrt{xᵢ²+yᵢ²}.

$$τ = \frac{λ \cdot {y}_{i}}{{v}_{s} \cdot \sqrt{{x}_{i}^{2} + {y}_{i}^{2}}} \qquad Equation 1$$

In the transforming the three dimensional topographic plan into a sound map, the distance is preferably modeled by representing sound delivered to the user as a series of short, substantially equally spaced pulses at a predetermined frequency of delivery. The frequency of delivery of the sound pulses is preferably less than 20 Hz, corresponding to the approximate low frequency human hearing threshold, and more preferably between 10 to 20 Hz. A 10 Hz frequency of sound delivery would provide five sounding and five non-sounding intervals each second, while a 20 Hz frequency of sound delivery would provide ten sounding and ten non-sounding intervals each second. Farther objects are preferably modeled at a higher frequency, whereby as a user approaches an object, the frequency of sound delivery increases. For example, if a predetermined range of the sound mapping device 10 is 20 meters, a surface at a distance of 20 meters from a user may be modeled at 10 Hz, while a surface which is very close to a user may be modeled at 20 Hz. More preferably, distance is modeled by representing sound delivered to the user as the series of short, substantially equally spaced pulses at a predetermined frequency of delivery for areas only within the near zone of the topographic plan, and in the far zone, distance is defined instead by a discreet sound frequency, wherein a lower tone is associated with surfaces which are farther away, and a higher tone is associated with surfaces which are closer.

Preferably, the sound synthesizing engine 148 is configured to transmit the sound signals comprising the sound map to the audio outputs 18 discretely at predetermined intervals such that a user of the system can hear environmental sounds during time periods between transmissions of the sound signals. As a user repositions the sound mapping device 10, for example by walking or moving his or her head, the sound map is updated as new images are processed. Preferably, transmission of the sound signals comprising the sound map to the audio outputs 18 occurs every 10 seconds for a 3 second duration. Alternatively, any suitable predetermined interval may be implemented and/or the predetermined interval may be user-selectable. For example, within a very rugged environment, the sound map is preferably transmitted to the audio outputs 18 every 3 seconds for a 2 second duration.

For the purpose of color recognition, the sound synthesizing engine 148 is preferably configured to model color gamma. Three main colors of the topographic plan, red, blue and green are preferably modeled by three sound timbres. If the sound synthesizing engine 148 is configured to model image brightness level with sound tones, a higher octave timbre representing the color or colors is superimposed over a main tone representing the image brightness levels of the topographic plan irrespective of color. Preferably, the red color is represented by the highest heard octave, the green color is modeled by an octave lower than that of the red color, and the blue color is modeled by an octave lower than that of the green color. The main tone, representing image brightness level irrespective of color, is preferably modeled in one or more octaves which are lower than the octaves of the red, green and blue colors and at frequencies which do not extend into the frequencies reserved for color modeling. Colors such as purple which are mixtures of the main red, green and blue colors are preferably represented by a mixture of two or more of the tones representing the colors, the intensity of each of which is proportional to the color presence within the visual specter.

The sound synthesizing engine 148 is preferably configured to model the surface texture matrix by delivering the main tone and/or the color tones as recognizable imitations of naturally occurring sounds. Tree leaves are preferably modeled with a rustling forest sound while asphalt is preferably modeled as resonating footsteps on a hard surface. A database of other sounds including other sound imitations is preferably provided.

One skilled in the art will recognize that all, some or each of the brightness determining engines 126, 128, parallax field forming engine 132, the block of cuts forming engine 134, the topographical plan building engine 136 and the sound synthesizing engine 148 may be provided as one or more processors and/or other components, with the algorithms used for performing the functionality of these engines being hardware and/or software driven. One skilled in the art will further recognize that the memory 130 may be provided as one or more memories of any suitable type.

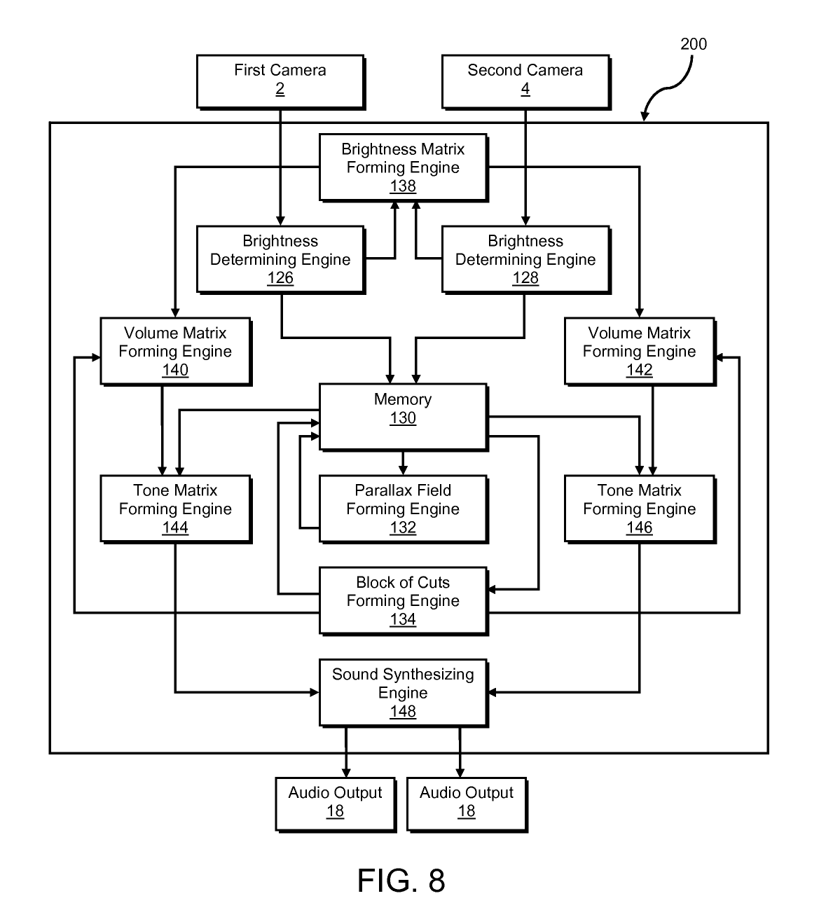

FIG. 8 shows diagrammatically components of the sound mapping device 10 utilizing a second preferred image processing system 200 in place of the first image processing system 100 and including some of the same functional components as the first preferred image processing system 100, wherein identically named components perform substantially identical functions. Referring to FIG. 8, the image processing system 200 includes a brightness matrix forming engine 138 connected to the brightness determining engines 126, 128 for creating a brightness gradient matrix. The brightness gradient matrix is preferably constructed based on the relative positioning and the brightness magnitude of the localized extreme points 110. Alternatively, the brightness matrix forming engine can form the brightness gradient matrix from any suitable interpretation of the images received from the first and/or second cameras 2, 4.

Volume matrix forming engines 140, 142 are connected to the block of cuts forming engine 134 and the brightness matrix forming engine 138, and they are configured to create sound volume gradient matrices based on the physical positions of the portions of the three dimensional view area represented by the localized extreme points 110, for example the physical position 1110, and the relative brightness magnitude of the localized extreme points. The volume matrix forming engines 140, 142 preferably create the volume gradient matrices through a superimposing of the brightness gradient matrix delivered by the brightness matrix forming engine 138 over the matrix of interpolated vertical and horizontal cuts delivered by the block of cuts forming engine 134 to provide data for regulating sound volume of a sound map. Alternatively, the volume gradient matrices may be formed by any suitable interpretation of the brightness gradient matrix.

Preferably, each of the volume matrix forming engines 140, 142 creates a volume gradient matrix representative of one side of a three dimensional view area. For example, the volume matrix forming engine 140 may receive data associated with the left side of the three dimensional view area 101 and form a matrix representing the left side of the three dimensional view area 101, and the volume matrix forming engine 142 may receive data associated with the right side of the three dimensional view area 101 and form a matrix representing the right side of the three dimensional view area.

Tone matrix forming engines 144, 146 are connected to the block of cuts forming engine 134 through the memory 130 and are configured to create sound tone gradient matrices based on the physical positions of the three dimensional view area represented by the localized extreme points 110, for example the physical position 1110. The tone matrix forming engines 144, 146 preferably create the tone gradient matrices through an interpretation of the matrix of interpolated vertical and horizontal cuts delivered by the block of cuts forming engine 134 to provide data for regulating sound tone of a sound map. Preferably, each of the tone matrix forming engines 144, 146 creates a tone gradient matrix representative of one side of the three dimensional view area 101. For example, the tone matrix forming engine 144 may receive data associated with the left side of the three dimensional view area 101 and form a matrix representing the left side of the three dimensional view area 101, and the tone matrix forming engine 146 may receive data associated with the right side of the three dimensional view area 101 and form a matrix representing the right side of the three dimensional view area 101.

Preferably, each of the tone matrix forming engines 144, 146 creates a three dimensional topographic plan by superimposing a respective one of the volume gradient matrices over its tone gradient matrix. The three dimensional topographic plans of the tone matrix forming engines 144, 146 are transmitted to the sound synthesizing engine 148 which transforms the three dimensional topographic plans into a stereophonic sound map comprising volume gradients and tone gradients. The stereophonic sound map is transmitted in the form of sound signals to the audio outputs 18 from the sound synthesizing engine 148 for reception by a user.

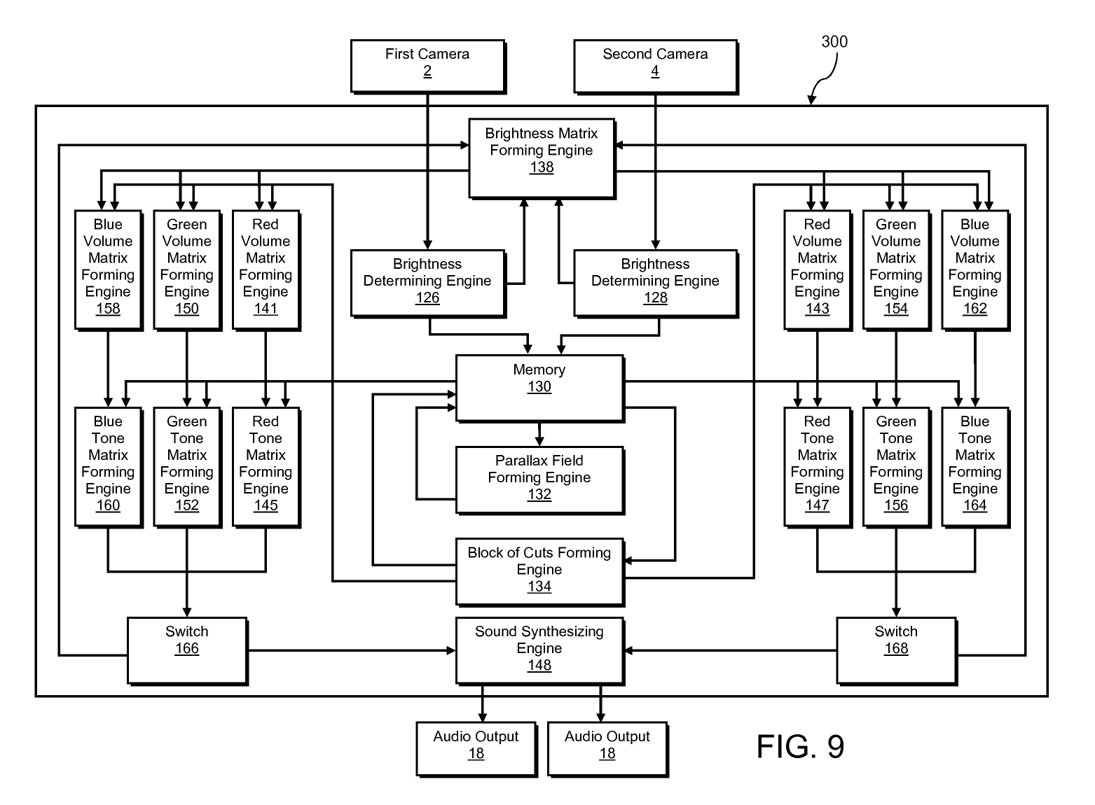

FIG. 9 shows diagrammatically components of the sound mapping device 10 utilizing a third preferred image processing system 300 in place of the first image processing system 100 and including some of the same functional components as the first preferred image processing system 100, wherein identically named components perform substantially identical functions. Referring to FIG. 9, the image processing system 300 includes a brightness matrix forming engine 138 connected to the brightness determining engines 126, 128 for creating a brightness gradient matrix. The brightness gradient matrix is preferably constructed based on the relative positioning and the brightness magnitude of the localized extreme points 110. Alternatively, the brightness matrix forming engine 138 can form the brightness gradient matrix from any suitable interpretation of the images received from the first or second cameras 2, 4.

Color-specific volume matrix forming engines 143, 154, 162, 141, 150, 158 are connected to the block of cuts forming engine 134 and the brightness matrix forming engine 138, and they are configured to create sound volume gradient matrices based on the physical positions of the portions of the three dimensional view area represented by the localized extreme points 110, for example the physical position 1110, and the color-specific relative brightness magnitude of the localized extreme points. The relative brightness magnitude of red light is processed in one of the red volume matrix forming engines 141, 143. The relative brightness magnitude of green light is processed in one of the green volume matrix forming engines 150, 154. The relative brightness magnitude of blue light is processed in one of the blue volume matrix forming engines 158, 162.

Preferably, a first bank of the color-specific volume matrix forming engines 143, 154, 162 creates color-specific sound volume gradient matrices representative of one side of the three dimensional view area 101 and the color-specific volume matrix forming engines 141, 150, 158 create color-specific sound volume gradient matrices representative of an opposing side of the three dimensional view area. Preferably, the red volume matrix forming engine 141 receives data associated with the left side of the three dimensional view area 101 and forms a matrix representing the red light reflected from the left side of the three dimensional view area 101, and the other red volume matrix forming engine 143 receives data associated with the right side of the three dimensional view area 101 and forms a matrix representing the red light reflected from the right side of the three dimensional view area 101, whereby the two red sound volume gradient matrices formed by the red volume matrix forming engines 141, 143 are representative of the entire three dimensional view area 101. The blue and green volume matrix engines 154, 162, 150, 158 function in a similar manner forming color-specific matrices respectively corresponding to blue and green light reflected from opposing sides of the three dimensional view area 101.

The color-specific volume matrix forming engines 143, 154, 162, 141, 150, 158 preferably create the volume gradient matrices through a superimposing of the brightness gradient matrix delivered by the brightness matrix forming engine 138 over the matrix of interpolated vertical and horizontal cuts delivered by the block of cuts forming engine 134 to provide data for regulating sound volume of a sound map. Alternatively, the volume gradient matrices may be formed by any suitable interpretation of the brightness gradient matrix.

Color-specific tone matrix forming engines 145, 152, 160, 147, 156, 164 are connected to the block of cuts forming engine 134 and are configured to create color-specific sound tone gradient matrices based on the physical positions of the three dimensional view area represented by the localized extreme points 110, for example the physical position 1110. The color-specific tone matrix forming engines 145, 152, 160, 147, 156, 164 preferably create the color-specific tone gradient matrices through an interpretation of the matrix of interpolated vertical and horizontal cuts delivered by the block of cuts forming engine 134 to provide data for regulating sound tone of a sound map.

Preferably, a first bank of the color-specific tone matrix forming engines 145, 152, 160 creates color-specific sound tone gradient matrices representative of one side of the three dimensional view area 101 and the color-specific tone matrix forming engines 147, 156, 164 create color-specific tone gradient matrices representative of an opposing side of the three dimensional view area 101. Preferably, the red tone matrix forming engine 145 receives data associated with the left side of the three dimensional view area 101 and forms a matrix representing the red light reflected from the left side of the three dimensional view area 101, and the other red tone matrix forming engine 147 receives data associated with the right side of the three dimensional view area and forms a matrix representing the red light reflected from the right side of the three dimensional view area 101, whereby the two red tone matrices formed by the red tone matrix forming engines 145, 147 are representative of the entire three dimensional view area 101. The blue and green tone matrix engines 152, 160, 156, 164 function in a similar manner forming color-specific tone matrices respectively corresponding to blue and green light reflected from opposing sides of the three dimensional view area 101.

Preferably, each of the color-specific tone matrix forming engines 145, 152, 160, 147, 156, 164 creates a three dimensional topographic plan by superimposing a respective one of the volume gradient matrices over its tone gradient matrix. The three dimensional topographic plans of the color-specific tone matrix forming engines 145, 152, 160, 147, 156, 164 are transmitted to the sound synthesizing engine 148 which transforms the three dimensional topographic plans into a stereophonic sound map comprising color-specific volume gradients and tone gradients. Preferably, switches 166 and 168 are provided for alternately sending data to the sound synthesizing engine 148 for sound map production and to the brightness matrix forming engine for building 138 for continuing building of the topographic plan. The stereophonic sound map is transmitted to the audio outputs 18 from the sound synthesizing engine 148 for reception by a user.

One skilled in the art will recognize that components of the second and third preferred processing systems 200, 300, including but not limited to the brightness matrix forming engine 138, volume matrix forming engines 140, 142, 141, 150, 158, 143, 154, 162 and tone matrix forming engines 144, 146, 145, 152, 160, 147, 156, 164, may be provided as one or more processors, with the algorithms used for performing their functionality being hardware and/or software driven.

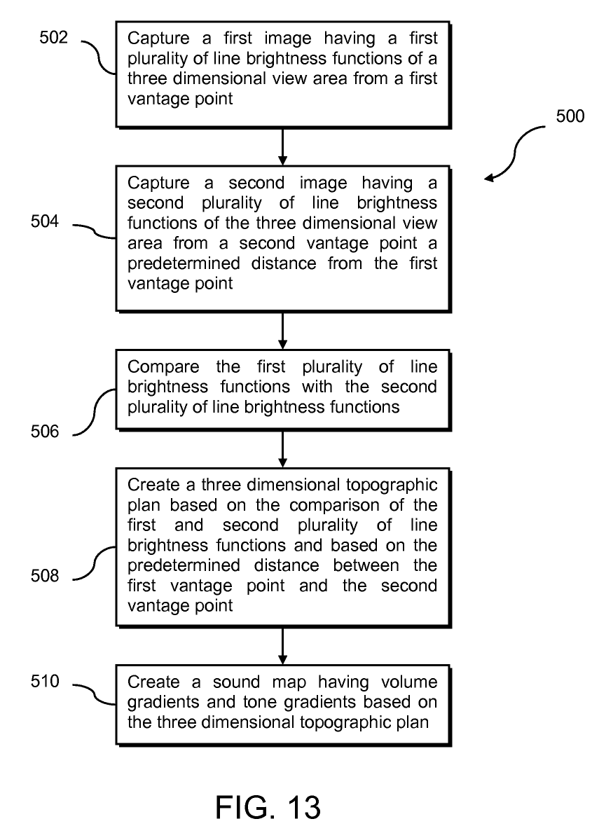

Referring to FIG. 13, a diagram showing a method 500 of creating a sound map of a three dimensional view area is shown. The method includes capturing a first image of the three dimensional view area from a first vantage point (step 502), whereby the first image comprises a first plurality of line brightness functions, and capturing a second image of the three dimensional view area from a second vantage point a predetermined distance from the first vantage point (step 504), whereby the second image comprises a second plurality of line brightness functions. The first plurality of line brightness functions is compared with the second plurality of line brightness functions (step 506), and a three dimensional topographic plan is created based at least on the comparison of the first and second plurality of line brightness functions and based on the predetermined distance between the first vantage point and the second vantage point (step 508). A sound map is created based on the three dimensional topographic plan, wherein the sound map comprises volume gradients and tone gradients (step 510).

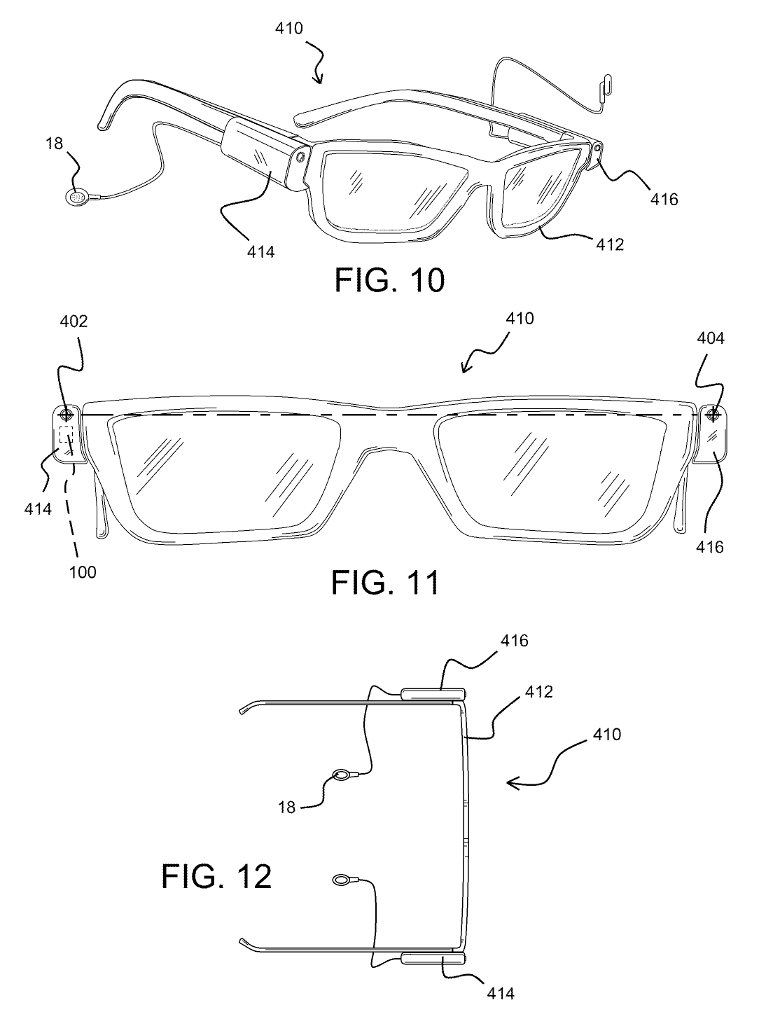

Referring to FIGS. 10-12, a device 410 in the form of a pair of glasses having spectacle frames 412 for creating a sound map of a three dimensional view area according to another preferred embodiment of the present invention is shown. The sound mapping device 410 includes a body 414 holding a first camera 402 configured to capture and transmit an image and a body 416 holding a second camera 404 positioned a predetermined distance from the first camera 402 configured to capture and transmit an image. The device 410 is preferably configured to utilize the first preferred image processing system 100 housed in the body 414 and connected to the first camera 402 and the second camera 404. The bodies 414, 416 each preferably include a battery for respectively providing power to the first and second cameras 402, 404 and the image processing system 100.

The image processing system 100 functions in substantially the same manner to create a three dimensional topographic plan of a three dimensional view area and a sound map comprising volume gradients and tone gradients when implemented in the device 410 of the preferred invention embodiment of FIG. 10 as it does when implemented in the device 10 of the preferred invention embodiment of FIG. 1. However, since the cameras 402, 404 are oriented aligned within a horizontal plane, the image processing system 100 is preferably configured to perform triangulation for a given pair of localized extreme points 110 in a horizontal plane rather than a vertical plane as shown in FIGS. 4-6. Accordingly, horizontal cuts are preferably determined using the comparison of the localized extreme points 110, and vertical cuts are interpolated. The resulting sound map created by the image processing system is preferably emitted through audio outputs 18. Alternatively, the device 410 can implement the second preferred image processing system 200 or the third preferred image processing system 300 to create and emit a sound map.

While the preferred embodiments of the invention have been described in detail above and in the attached Appendix, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. A device for creating a sound map of a three dimensional view area, the device comprising:
a first camera configured to capture and transmit a first image;
a second camera positioned a predetermined distance from the first camera configured to capture and transmit a second image; and
an image processing system connected to the first camera and the second camera configured to create a three dimensional topographic plan of the three dimensional view area based at least on a comparison of the first image with the second image and the predetermined distance between the first camera and the second camera, and configured to transform the three dimensional topographic plan into a sound map comprising volume gradients and tone gradients.

2. The device of claim 1, further comprising:
at least one frame member connected to the first camera and the second camera for attaching the device to a user; and
at least one audio output connected to the image processing system for transmitting the sound map to the user.

3. The device of claim 2, wherein the at least one frame member comprises a pair of spectacle frames for wearing on the head of a user, and the at least one audio output comprises a pair of speakers.

4. The device of claim 1, wherein the image processing system comprises:
at least one brightness determining engine connected to the first camera and the second camera configured to identify and quantify localized extreme points of the first image and the second image;
at least one parallax field forming engine connected to the at least one brightness determining engine configured to determine parallaxes between corresponding localized extreme points of the first image and the second image;
at least one block of cuts forming engine connected to the at least one parallax field forming engine configured to determine physical positions of portions of the three dimensional view area represented by the localized extreme points of the first image and the second image relative to at least one of the first camera and the second camera based on the determination of the parallaxes and the predetermined distance between the first camera and the second camera;
at least one topographical plan building engine configured to create the three dimensional topographic plan based at least on the physical positions of the portions of the three dimensional view area represented by the localized extreme points determined by the at least one block of cuts forming engine; and
at least one sound synthesizing engine connected to the topographical plan building engine configured to transform the three dimensional topographic plan into a sound map comprising volume gradients and tone gradients.

5. The device of claim 4, wherein the at least one topographical plan building engine comprises:
at least one brightness matrix forming engine connected to the at least one brightness determining engine, the at least one brightness matrix forming engine configured to create a brightness gradient matrix based on the relative positioning and the brightness magnitude of the localized extreme points;
at least one volume matrix forming engine connected to the at least one block of cuts forming engine and the at least one brightness matrix forming engine configured to create a volume gradient matrix based at least on the physical positions of the portions of the three dimensional view area represented by the localized extreme points and the relative brightness magnitude of the localized extreme points; and
at least one tone matrix forming engine connected to the at least one block of cuts forming engine configured to create a tone gradient matrix based at least on the physical positions of the portions of the three dimensional view area represented by the localized extreme points.

6. The device of claim 4, wherein the at least one topographical plan building engine comprises:
at least one brightness matrix forming engine connected to the at least one brightness determining engine, the at least one brightness matrix forming engine configured to create a brightness gradient matrix based on the relative positioning and the brightness magnitude of the localized extreme points;
a plurality of volume matrix forming engines connected to the at least one block of cuts forming engine and the at least one brightness matrix forming engine, the plurality of volume matrix forming engines configured to create a plurality of color-specific volume gradient matrices based at least on the physical positions of the portions of the three dimensional view area represented by the localized extreme points and the color-specific relative brightness magnitude of the localized extreme points; and
a plurality of tone matrix forming engines connected to the at least one block of cuts forming engine configured to create a plurality of color-specific tone gradient matrices based at least on the physical positions of the portions of the three dimensional view area represented by the localized extreme points;
wherein the at least one sound synthesizing engine is connected to the plurality of tone matrix forming engines and the plurality of volume matrix forming engines and is configured to transform the color-specific tone gradient matrices and the color-specific volume gradient matrices into a sound map comprising volume gradients and tone gradients.

7. The device of claim 1, wherein the image processing system comprises:
at least one brightness determining engine connected to the first camera and the second camera configured to at least one of create a plurality of coplanar pairs of line brightness functions from the first and second images and receive the first and second images as a plurality of coplanar pairs of line brightness functions, wherein the plurality of coplanar pairs of line brightness functions comprise a first plurality of line brightness functions from the first camera and a second plurality of line brightness functions from the second camera, wherein each of the first plurality of line brightness functions represents a cut of the three dimensional view area which is substantially coplanar with a cut of the three dimensional view area represented by at least one of the second plurality of line brightness functions, and wherein the at least one brightness determining engine is configured to identify localized extreme points of the line brightness functions;
at least one parallax field forming engine connected to the at least one brightness determining engine configured to determine parallaxes between corresponding ones of the localized extreme points of the coplanar pairs of brightness functions;
at least one block of cuts forming engine connected to the at least one parallax field forming engine configured to determine physical positions of the portions of the three dimensional view area represented by the localized extreme points relative to the first camera and the second camera based on the determination of the parallaxes and the predetermined distance between the first camera and the second camera;
at least one topographical plan building engine connected to the at least one block of cuts forming engine configured to create the three dimensional topographic plan based at least on the physical positions of the portions of the three dimensional view area represented by the localized extreme points determined by the at least one block of cuts forming engine; and
at least one sound synthesizing engine connected to the topographical plan building engine for transforming the three dimensional topographic plan into a sound map comprising volume gradients and tone gradients.

8. The device of claim 1, wherein the image processing system is configured to identify localized extreme points of the first image and the second image and to determine physical positions of the portions of the three dimensional view area represented by the localized extreme points relative to the first camera and the second camera to create the three dimensional topographic plan of the three dimensional view area.

9. A method of creating a sound map of a three dimensional view area comprising:
providing a first camera directed toward the three dimensional view area;
providing a second camera directed toward the three dimensional view area and positioned a predetermined distance from the first camera;
providing a processing system connected to the first camera and the second camera;
transmitting a first image of the three dimensional view area from the first camera to the processing system;
transmitting a second image of the three dimensional view area from the second camera to the processing system;
comparing the first image with the second image and creating a three dimensional topographic plan with the processing system based on the comparison of the first image and the second image and the predetermined distance between the first camera and the second camera; and
transforming using the processing system the three dimensional topographic plan into a sound map comprising volume gradients and tone gradients.

10. The method of claim 9, further comprising:
transmitting the first image and the second image to the processing system as a plurality of coplanar pairs of line brightness functions of the three dimensional view area, wherein each of the plurality of coplanar pairs of line brightness functions comprises a first line brightness function from the first camera and a second line brightness function from the second camera, wherein the first line brightness function represents a cut of the three dimensional view area which is substantially coplanar with a cut of the three dimensional view area represented by the second line brightness function;
identifying localized extreme points on the first line brightness functions and the second line brightness functions using the processing system;
determining parallaxes between corresponding ones of the localized extreme points of the plurality of coplanar pairs of line brightness functions using the processing system;
determining physical positions of the portions of the three dimensional view area represented by the localized extreme points relative to the first camera and the second camera based on the determination of the parallaxes and the predetermined distance between the first camera and the second camera using the processing system; and
creating the three dimensional topographic plan based at least on the physical positions of the portions of the three dimensional view area represented by the localized extreme points relative to the first camera and the second camera using the processing system.

11. The method of claim 10, further comprising using the processing system to normalize the determined physical positions of the portions of the three dimensional view area represented by the localized extreme points relative to the first camera and the second camera with respect to a ground plane.

12. The method of claim 10, further comprising using the processing system to triangulate the physical positions of the portions of the three dimensional view area represented by the localized extreme points relative to the first camera and the second camera.

13. The method of claim 10, further comprising using the processing system to determine physical positions of portions of the three dimensional view area represented by points between the localized extreme points in each of the plurality of coplanar pairs of line brightness functions by interpolating between the determined physical positions of portions of the three dimensional view area represented by the localized extreme points at a predetermined resolution to create an interpolation of the cuts of the three dimensional view area.

14. The method of claim 13, further comprising using the processing system to determine physical positions of portions of the three dimensional view area between the cuts of the three dimensional view area by interpolating between the determined interpolation of the cuts of the three dimensional view area at a predetermined resolution.

15. The method of claim 9, further comprising:
creating the three dimensional topographic plan with components of surface brightness and surface height using the processing system; and
modeling surface brightness as volume and modeling surface height as tone in transforming the three dimensional topographic plan into the sound map using the processing system.

16. The method of claim 9, further comprising providing at least two audio outputs connecting to the processing system and emitting the sound map stereophonically through the at least two audio outputs using the processing system.

17. A method for creating a sound map of a three dimensional view area comprising:
capturing a first image of the three dimensional view area including a surface from a first vantage point, whereby the first image comprises a first plurality of line brightness functions;
capturing a second image of the three dimensional view area including the surface from a second vantage point a predetermined distance from the first vantage point, whereby the second image comprises a second plurality of line brightness functions;
comparing the first plurality of line brightness functions with the second plurality of line brightness functions and creating a three dimensional topographic plan based at least on the comparison of the first and second plurality of line brightness functions and based on the predetermined distance between the first vantage point and the second vantage point; and
creating a sound map based on the three dimensional topographic plan, wherein the sound map comprises volume gradients and tone gradients.

18. The method of claim 17, wherein the creating the sound map comprises modeling brightness levels of at least one of the first image and the second image within a first frequency range, and modeling at least one color of the at least one of the first image and the second image within a second frequency range outside of the first frequency range.

19. The method of claim 17, wherein the creating the sound map comprises modeling a distance from at least one of the first vantage point and the second vantage point to the surface as a series of spaced sound pulses at a frequency of delivery of less than about 20 Hz, wherein the frequency of delivery of the sound pulses is dependent on the distance from the at least one of the first vantage point and the second vantage point to the surface.

20. The method of claim 17, wherein the comparing the first plurality of line brightness functions with the second plurality of brightness functions comprises:
determining matching points of coplanar pairs of the first plurality of line brightness functions and the second plurality of line brightness functions;
determining a plurality of parallaxes between the matching points of the coplanar pairs of the first plurality of line brightness functions and the second plurality of line brightness functions; and
determining physical positions of portions of the three dimensional view area represented by the matching points relative to at least one of the first vantage point and the second vantage point based on the determination of the plurality of parallaxes and the predetermined distance between the first vantage point and the second vantage point.
